(19) United States
(12) Patent Application Publication
(10) Pub. No.: US 2025/0184320 A1
(43) Pub. Date: Jun. 5, 2025

(54) CONSORTIUM-BASED INFRASTRUCTURE AND PLATFORM FOR USER AUTHENTICATION

(71) Applicant: Kyndryl, Inc., New York, NY (US)

(72) Inventors: Sachio Iwamoto, Ontario (CA); Nadeem Malik, Austin, TX (US); Balaji Narasimhan, Cedar Park, TX (US); Kishor Grandhe, RoundRock, TX (US); Cesar Augusto Rodriguez Bravo, Alajuela (CR); Rajeev Puri, Huntersville, NC (US)

(21) Appl. No.: 18/524,145

(22) Filed: Nov. 30, 2023

(51) Int. Cl. H04L 9/40; H04L 9/00

(52) U.S. Cl. CPC H04L 63/0823; H04L 9/50

(57) ABSTRACT

In an aspect of the disclosure, a method includes: obtaining, by a computing device, a user request to access at least one system resource; obtaining, by the computing device, a digital certificate of the user requesting access to the at least one system resource; obtaining, by the computing device, a validation result associated with the digital certificate from a blockchain ledger network; determining, by the computing device, whether the validation result authorizes access to an authorization service; and sending the authorization to the authorization service to deny or permit the user access to the at least one system resource based on the validation result.

### BACKGROUND

Aspects of the present invention relate generally to an authentication system (infrastructure) and, more particularly, to a consortium-based infrastructure and platform for user authentication using a decentralized and self-sovereign identity.

Many user authentication methods are available to resources on servers, workstations, or other endpoint devices, e.g., smart phones, via login, ssh, login, etc., or web applications hosted on the internet or on private application servers. For example, a known authentication method relies on user ID and password combinations. Various other methods are available including biometric technology (e.g., fingerprint scanning and facial recognition), PKI certificates, ssh keys, or JSON Web Tokens (JWT), etc.

In each of these different methods, the credentials are stored locally at each endpoint or remotely in database (e.g., LDAP). In any case, the credentials are managed by a central governing authority, e.g., an IT department or security operation center of an organization or a third party enterprise managed ID provider (IDP) solution such as a social media service using OpenId/OAuth 2.0 protocol. By using these existing centralized authentication solutions, for example, there is a need to manage many IDs and passwords. Also, these methods pose security risks as IDs and passwords can be exposed and used by hackers. Moreover, there are privacy risks, in addition to such methods being inflexible and complex to realize across multiple organizations or communities when the credentials and authorization policies are per device or organization basis.

### SUMMARY

In a first aspect of the invention, there is a computer-implemented method including: obtaining, by a computing device, a user request to access at least one system resource; obtaining, by the computing device, a digital certificate of the user requesting access to the at least one system resource; obtaining, by the computing device, a validation result associated with the digital certificate from a blockchain ledger network; determining, by the computing device, whether the validation result authorizes access to an authorization service; and sending authorization to the authorization service to deny or permit the user access to the at least one system resource based on the validation result.

In another aspect of the invention, there is a computer program product including one or more computer readable storage media having program instructions collectively stored on the one or more computer readable storage media. The program instructions are executable to: obtain a user request to access at least one system resource; obtain verifiable credentials of the user requesting access to the at least one system resource; validate the verifiable credentials with a blockchain ledger network; and permit the user access to the at least one system resource based on a successful validation result.

In another aspect of the invention, there is system including a processor, a computer readable memory, one or more computer readable storage media, and program instructions collectively stored on the one or more computer readable storage media. The program instructions are executable to: bridge communication between at least one authentication module and a blockchain ledger network, comprising: obtaining verifiable credentials of multiple users from the at least one authentication module at the endpoints; receiving verification from the block chain ledger network that the verifiable credentials are valid and access to a service provided by any one of the multiple service providers that issued the verifiable credentials is authorized; and providing authorization to the at least one authentication module that a user requesting a service from any of the multiple service providers can access the service.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a swim lane diagram of an exemplary method in accordance with aspects of the invention.

### DETAILED DESCRIPTION

Aspects of the present invention relate generally to an authentication system (infrastructure) and, more particularly, to a consortium-based infrastructure and platform for user authentication using a decentralized and self-sovereign identity. In an embodiment, the decentralized and self-sovereign identity is implemented using individual digital certificates in blockchain technologies (e.g., blockchain ledger network for self-sovereign identity). The digital certificate of each user includes verifiable credentials that are used to authenticate the user and authorize the user to access or execute different system resources, without the need for centralized management. In this manner, implementations of the invention provide an open ecosystem to authenticate users without the need for individual passwords or user IDs for each application or endpoint (e.g., system resources) and which, in a decentralized and autonomous manner, authorizes user access to the system resources. Accordingly, the system and method (e.g., tools) described herein provide a technical solution to a technology based problem by simplifying and automating authentication and authorization workflows.

According to aspects of the invention, the decentralized and self-sovereign identity is utilized in a community or consortium-based security model, which is configured to authenticate users to login to endpoints. By utilizing blockchain-based technologies (e.g., a blockchain ledger network) in a community or consortium-based dynamic authorization security model, authorization and access to end points or applications (e.g., system resources) is provided without the need for individual passwords or the reliance on a single central governing authority or intermediary third-parties to gain access to system resources. The authentication process may also utilize business-policy based access control (e.g., different policies and different rules for different organizations) in a dynamic and flexible manner. For example, in an embodiment, the business-policy based access control provided by an issuer of the digital certificate (e.g., by a credential issuer) is authenticated utilizing a centralized unified security bridge that implements and utilizes the blockchain technologies.

In aspects, the centralized, unified security bridge spans between, e.g., the blockchain ledger network, multiple pluggable authentication modules, a verifying agent and issuers of the user credentials. The multiple pluggable authentication modules may be endpoints such as servers, smartphones, workstations, tablets, or other devices, that provide access to different system resources. The system resources may be, for example, web-based applications, e.g., email applications, cloud based applications, streaming services, software applications stored internally or over the cloud, etc. In this way, the system and method simplifies and automates the authentication and authorization workflow utilizing a plurality of third-party credentials issued to plural users and which can be authenticated through a single, centralized security bridge.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

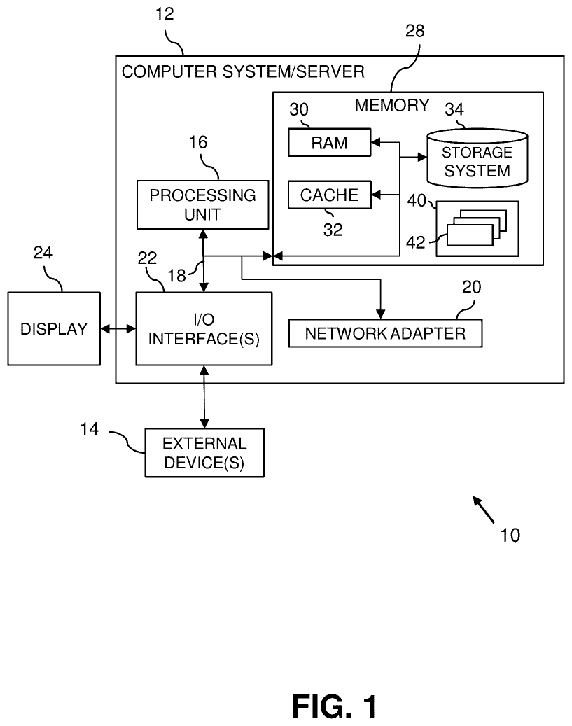

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

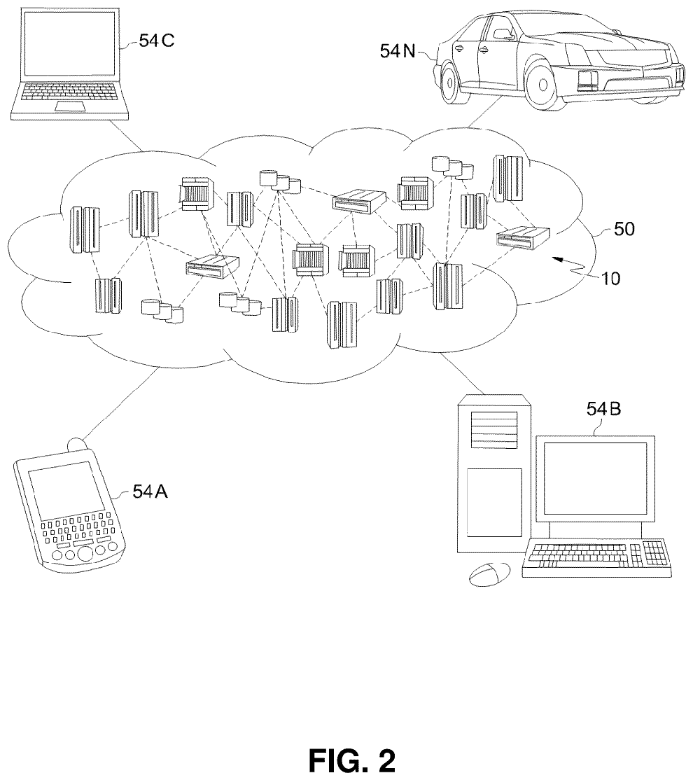

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

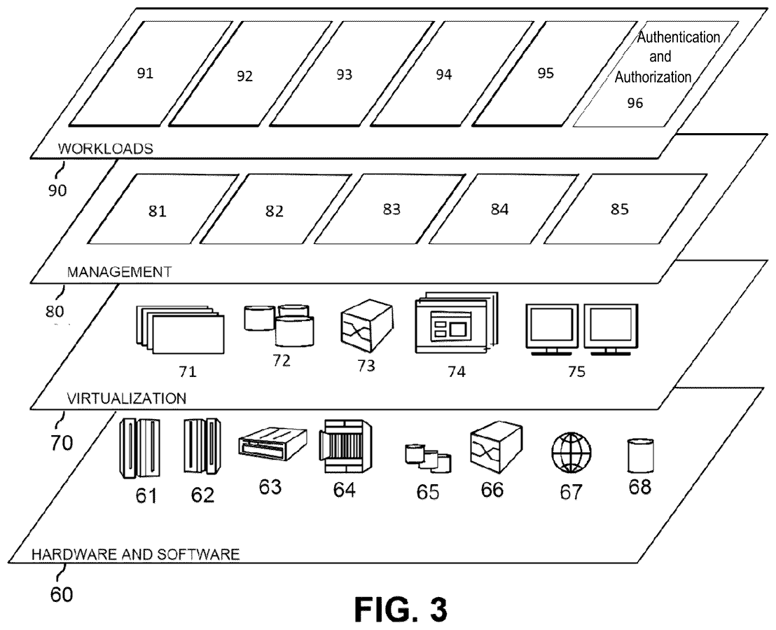

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and authentication and authorization 96.

Implementations of the invention may include a computer system/server 12 of FIG. 1 in which one or more of the program modules 42 are configured to perform (or cause the computer system/server 12 to perform) one of more functions of the authentication and authorization layer 96 of FIG. 3. For example, the one or more of the program modules 42 may be configured to provide a community or consortium driven password-less authentication solution that allows users to be authenticated and authorized to access and execute different system resources at different endpoints, without the use of a centralized management.

In more specific embodiments, the authentication and authorization layer 96 (implemented in the one or more of the program modules 42) provides a community or consortium-based security model to authenticate users to login to endpoints and authorize access and execution of system resources using a decentralized and self-sovereign identity (SSI) security model. The model provides an open ecosystem to authenticate users without the need, for example, user ID and password combinations, biometrics, PKI certificates, ssh keys, or JSON Web Tokens (JWT), etc. Instead, this open ecosystem will authorize the access to system resources in a decentralized and autonomous manner.

In more specific embodiments, the authentication and authorization layer 96 provides:
(i) users with the ability to be authenticated to log into endpoints and system resources without relying on a single central governing authority or intermediary third-parties;
(ii) a unified interface bridging between a blockchain-based platform and multiple pluggable authentication modules on endpoints to simplify and automate the authentication and authorization workflow;
(iii) a security model to allow multiple organizations to use the same model by registering their domain; and
(iv) users the ability of authentication based on credentials provided by third-party issuers of digital certificates.

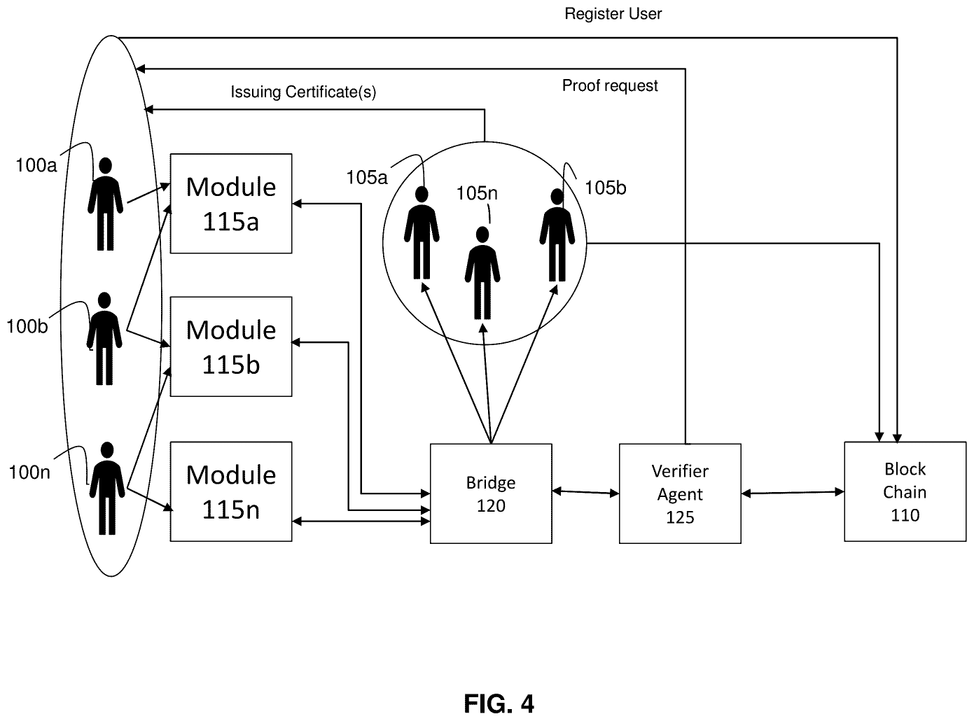

Also, and advantageously, the authentication and authorization layer 96 is scalable and resilient. For example, the authentication and authorization layer 96 takes advantage of all blockchain features including, for example, being distributed, decentralized, and immutable. Therefore, the backend platform (e.g., unified security bridge 120 of FIG. 4) to support the security model described herein is scalable, reliable, and resilient. Moreover, the authentication and authorization layer 96 improves security and privacy as it does not rely on passwords which have a risk of being exposed, thus preventing hackers from attacking by unwanted correlation, sniffing keyboard, etc. The credentials are also owned and controlled by the users instead of being stored on servers that provide SSO solutions or directory services. Also, the backend platform (e.g., unified security bridge 120 of FIG. 4) is autonomous, with the users controlling the ownership of personal information, hence enhancing privacy.

In addition, the authentication and authorization layer 96 is a feature rich dynamic access control list, which provides autonomous and decentralized credentials. This makes possible a wide variety of access policies to protect system resources at the endpoints or applications. The policies, e.g., business rules, can be dynamically controlled and will enable new business use cases. Further, the authentication and authorization layer 96 provides unified and simplified authentication which enables the same security model for multiple endpoint attack vectors.

FIG. 4 shows a block diagram of an exemplary environment in accordance with aspects of the invention. In embodiments, the environment includes a plurality of users 100a, 100b . . . 100n, each of which has an associated digital wallet that holds digital certificates. In embodiments, the digital certificates include verifiable credentials that may be issued by any number of user credential issuers 105a, 105b . . . 105n as described herein. As should be understood by those of skill in the art, the digital wallet is 100% secure and everything in the digital wallet is trusted.

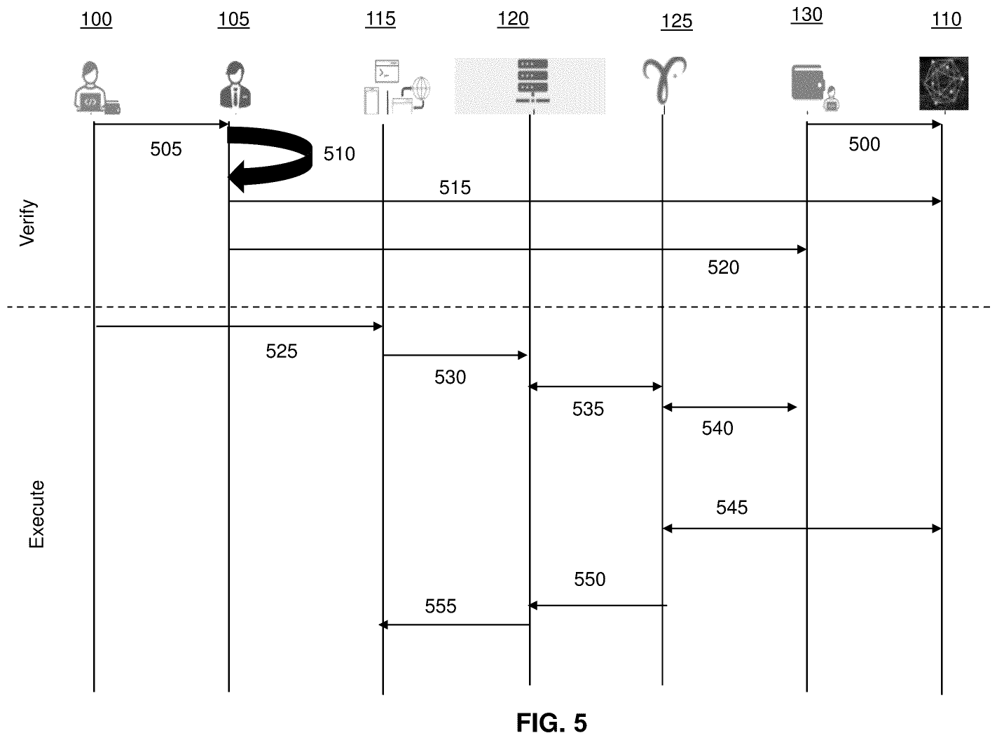

The digital certificates (e.g., credentials) are stored in the cloud environment as shown in FIG. 2, for example, using a mobile digital wallet and will be used at the time of authentication to verify with a blockchain ledger 110 as described herein. For example, the digital wallet is connected to the blockchain network via a holder agent (as described in FIG. 5) for the users 100a, 100b . . . 100n. An exemplary holder agent is a component of HyperLedger Aries toolkit. Hyperledger Aries toolkit or any holder agent toolkit contemplated herein is a complete toolkit for decentralized identity solutions and digital trust. The holder agent will issue, store and present verifiable credentials with maximum privacy preservation, and establish confidential, ongoing communication channels.

The digital certificates can be issued by a plurality of different user credential issuers 105a, 105b . . . 105n. The user credential issuers 105a, 105b . . . 105n are community or consortium-driven trusted authorities. In embodiments, the user credential issuers 105a, 105b . . . 105n may be different service providers, which issue digital certificates to authenticate a user 100a, 100b . . . 100n to access and execute different system resources, e.g., applications and/or services owned or managed by the user credential issuers 105a, 105b . . . 105n. For example, the user credential issuers 105a, 105b . . . 105n may be a SaaS provider (e.g., application providers who host applications that the users consume), corporate manager, municipal officer (government agency such as department of motor vehicle that issues driver's license or a state department that issues valid passports), etc. The system resources may be any software product such as a web-based application, internal software product, streaming service, web based accounts, etc., whether residing on the Internet or cloud based infrastructure as shown in FIG. 2, for example. The user credential issuers 105a, 105b . . . 105n are also responsible for examining the authenticity of users upon request by the users (e.g., wallet holders).

In embodiments, the user credential issuers 105a, 105b . . . 105n may set policies and/or rules which are provided within the digital certificates for the user to gain access to a particular application and/or service. These policies and/or rules may be, for example, “or” rules or “and/or” rules. By way of illustration, a rule may be a user needs to be a graduate from “X” university or have “Y” job title or be a member of “A” charity or organization to be authenticated for access to “Z” web-based service. Another rule may be a user needs to be an employee of “X” corporation and have a particular job title. Of course, different policies and/or rules are also contemplated herein. In any of these scenarios, the user credential issuers 105a, 105b . . . 105n set the policies and/or rules, determine whether the plurality of users 100a, 100b . . . 100n wanting to access and/or execute a system resource meet the criteria for any of the policies and/or rules and issue a digital certificate with such qualifications for each of the plurality of users 100a, 100b . . . 100n. Accordingly, the user credential issuers 105a, 105b . . . 105n will issue verifiable credentials, e.g., verifiable digital certificate, when they confirm that the users satisfy certain criterion.

The plurality of users 100a, 100b . . . 100n register with a blockchain network 110. The blockchain network 110 is a blockchain ledger network for self-sovereign (SSI). The blockchain ledger network for self-sovereign identity 110 is a purpose-built permissioned distributed blockchain ledger network for decentralized identity to support verifiable credentials based on zero-knowledge proof (ZKP) technology. It should be understood by those of skill in the art that the blockchain ledger network for self-sovereign identity 110 may be multiple nodes in the network, with each node having a copy of the entire ledger.

Still referring to FIG. 4, each of the plurality of users 100a, 100b . . . 100n have access to one or more authentication modules 115a, 115b . . . 115n, which are subsystems that provide authentication and authorization services for system resources that can be consumed by authorized users. For example, one or more authentication modules 115a, 115b . . . 115n include applications such as SSH, SUDO, LOGIN, web applications or databases, or can be other endpoints such as a tablet, smartphone, servers, workstations or other computer infrastructures as shown and described with respect to FIG. 1. These web applications are often hosted by an operating systems (OS) on endpoint devices or over the Internet.

It should be understood that each of the authentication modules 115a, 115b . . . 115n comprise one or more program modules such as program modules 42 described with respect to FIG. 1. The authentication modules 115a, 115b . . . 115n may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

The environment also includes a unified security bridge 120 and a verifier agent 125. The unified security bridge 120 may be an abstraction layer as shown and described with respect to FIG. 3 and which implements the workload layer of authentication and authorization layer 96. More specifically, the unified security bridge 120 is a custom controller based on Hyperledger Aries where a set of common APIs is implemented to expand the capability of the self-sovereign identity.

The unified security bridge 120 bridges the communication between the authentication modules 115a, 115b . . . 115n at the endpoints and the blockchain ledger network 110, as an abstraction layer. The unified security bridge 120 is scalable and can be used for authentication amongst any number of authentication modules 115a, 115b . . . 115n, user credential issuers 105a, 105b . . . 105n and plurality of registered users 100a, 100b . . . 100n. Accordingly, the unified security bridge 120 is a unified interface bridging between a blockchain-based platform and multiple pluggable authentication modules on endpoints to simplify and automate the authentication and authorization workflow.

The unified security bridge 120 may also include business logics that realize a Business-rules-based Access Control (B-RBAC) model. In this way, access (read, write, execute) authorization for each user 100a, 100b . . . 100n may be programmatically implemented based on schema attribute values of more than one credential schemas from multiple application credential issuers. Accordingly, each user may include credentials (digital certificate) from multiple issuers which, depending on the business rules, all or any combination of which need to be verified (authenticated) for access to a system resource. Also, the unified security bridge 120 includes a database that stores the connection information between organizations (e.g., user credential issuers 105a, 105b . . . 105n) and holders of the digital wallet.

The verifier agent 125 is a component that enables peer-to-peer interactions between agents and/or the blockchain ledger network for self-sovereign identity 110. For example, the verifier agent 125 gathers the certificate from the certificate holder (e.g., holder agent), sends the certificate to the blockchain ledger network for self-sovereign identity 110, gathers the response and provides one or several responses to the unified security bridge 120. The unified security bridge 120 will, in turn, provide the authorization to access and/or execute a system resource at an end point. In this way, the unified security bridge 120 gathers all responses and performs the validation. The unified security bridge 120 also stores and implements the business rules provided by the user credential issuers 105a, 105b . . . 105n, which are verified within the digital certificate through the use of the blockchain ledger network for self-sovereign identity 110.

In an embodiment, the verifier agent 125 is a component of, for example, HyperLedger Aries toolkit. For example, in an embodiment, the verifier agent 125 can be a toolkit, e.g., an API, to validate the assets, e.g., credentials, in the digital certificate. More specifically, the verifier agent 125 is a trusted agent which provides agent processes controlled by credential verifiers (e.g., user credential issuers 105a, 105b . . . 105n) to verify the authenticity of digital assets like files, scripts, and applications, through the blockchain network. For example, the verifier agent 125 requests digital certificates from the wallet holder to authenticate the user based on the credentials in the digital certificate. Also, in an embodiment, the verifier agent 125 can be middleware which accesses the blockchain ledger network for self-sovereign identity 110 to determine whether the credential in the digital certificate remains active, has been revoked or has been changed in some manner. Also, the verifier agent 125 has an inherent trust with the user credential issuers 105a, 105b . . . 105n.

FIG. 5 shows a swim lane diagram of an exemplary method in accordance with aspects of the present invention. Steps of the method may be carried out in the environment of FIG. 4 and are described with reference to elements depicted in FIG. 4. In embodiments, steps 500 to 520 are steps to verify the application and issue credentials; whereas steps 525 to 555 are steps to execute an application (e.g., authenticate the user for access to a system resource). The steps of the swim lane diagram of FIG. 5 can be implemented with the following actors: the user 100, the user credential issuer 105, the authentication module 115, the unified security bridge 120, the verifier agent 125, a credential holder agent 130 and the blockchain ledger network for self-sovereign identity 110.

At step 500, the system creates a wallet for each user (if it does not already exist). This step is required only once until the digital wallet is deleted. In embodiments, for example, the credential holder agent 130 may register with the blockchain ledger network for self-sovereign identity 110.

At optional step 505, the user credential issuers 105 will issue a verifiable certificate. This may be initiated by a request from the users themselves. The user credential issuer 105 may also initiate the issuance of the credentials. If this is the case, the user credential issuer 105 will try to connect to the user 100 or the credential holder agent 130. The credential can be issued upon the user's acceptance.

At step 510, the user will be examined and certified by the user credential issuer 105. In embodiments, the processes issuers use to confirm the authenticity may vary. For example, when a new employee joins a company, the manager of the new hire may want to issue a credential that certifies the new hire is indeed an employee of the company.

At step 515, the user credential issuer 105 will verify the wallet holder's ID (e.g., user) by connecting to the blockchain ledger network for self-sovereign identity 110. At step 520, once the user credential issuer 105 confirms the authenticity of the digital wallet, the user credential issuer 105 will initiate the process to issue credentials and send the credentials to the user's digital wallet, e.g., credential holder agent 130.

At step 525, the user 100 attempts to access or login to the system resources using an endpoint, e.g., authentication module 115. This is performed through authentication services or applications such as SSH, SUDO, or Login for Linux. At step 530, the authentication module 115 (of the endpoint operating system) connects to the unified security bridge 120 for authentication. For example, authentication module 115 of the endpoint OS (e.g., Linux) will notify the software framework that controls authentication based on policies. Some operating system distributions provide the software framework natively. For example, Linux provides Pluggable Authentication Modules (PAM). The software framework service (e.g., PAM) can send attributes that are necessary to verify the authenticity of the user 100 to the unified security bridge 120.

At step 535, the unified security bridge 120 obtains the verifiable credentials of the user 100 from the wallet via the verifier agent 125. In alternative embodiments, the unified security bridge 120 obtains the verifiable credentials of the user 100 from the issuer of the certificate 105. Also, as already described herein, the unified security bridge 120 obtains the different rules from issuer of the certificate 105, which can be used against the verifiable credentials of the user 100 as obtained from the digital wallet. At step 540, the verifier agent 125 sends a proof request to the credential holder agent 130, which provides the credential(s) of the user 100 as a proof response back to the verifier agent 125.

At step 545, the verifier agent 125 verifies the wallet ID against the blockchain ledger network for self-sovereign identity 110 after it receives the credentials from the credential holder agent 130. For example, the verifier agent 125 sends a user ID verify key to the blockchain ledger network for self-sovereign identity 110 and the blockchain ledger network for self-sovereign identity 110 sends a user ID verification response back to the verifier agent 125.

At step 550, the verifier agent 125 sends a validation result to the blockchain ledger network for self-sovereign identity 110. At step 555, if verification is successful, the credential is valid and the schema attributes satisfy the defined policy, then a plug-in from the unified security bridge 120 sends the decision back to a kernel via the software framework service (e.g., the unified security bridge 120) to the authentication module 115 to allow the user to execute the system resources, e.g., application or service. If the credential is not valid, the login to the application or service will be denied by the blockchain ledger network for self-sovereign identity 110. In this way, only users with valid credentials, e.g., a valid credential as a cybersecurity employee, can access and execute authorized system resources.

Accordingly, by using the systems and methods provided herein, e.g., unified security bridge 120, the user will no longer require a password or user ID to gain access to or execute an application or service. For example, the user does not need to create different passwords for different accounts. Also, the credentials are no longer managed by a central governing authority security operation center of an organization or a third party enterprise managed ID provider (IDP) solution, which saves considerable resources and provides an additional layer of security and privacy.

### Example Use Case

In an example case, company “A” has a partnership with streaming service “B”. In this partnership, streaming service “B” provides employees of company “A” free access to a catalog of movies and a discount to other services. Instead of each employee creating a separate account with streaming service “B” in which streaming service “B” would have to manage, each employee will be issued a digital certificate from steaming service “B”. The digital certificate can include credentials registered in the blockchain ledger network for self-sovereign identity 110 and which can be held in the digital wallet of the user. The digital certificate will include the employee identification including the employee is an employee of company “A”, in addition to other relevant information such as any rule that they can only access the catalog of movies.

As the credentials of a digital certificate cannot be forged and are trusted by the blockchain ledger network for self-sovereign identity 110 and verifier agent 125, upon logging into the streaming service “B”, the digital certificate can be verified and the user can be authenticated for authorization to access the streaming service “B” using the unified security bridge 120. For example, the unified security bridge 120 can provide authorization to an endpoint device allowing the authorized user to access a movie within the movie catalogue of the streaming service “B”. If another service is requested by the user, the unified security bridge 120 can provide or deny access until a payment is received at which time, the processes will start again to verify the user and that payment has been made. In this way, the streaming service “B” will not have to manage any passwords, provide authentication or credential services or provide other verification services.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining, by a computing device, a user request to access at least one system resource;
obtaining, by the computing device, a digital certificate of the user requesting access to the at least one system resource;
obtaining, by the computing device, a validation result associated with the digital certificate from a blockchain ledger network;
determining, by the computing device, whether the validation result authorizes access to an authorization service; and
sending authorization to the authorization service to deny or permit the user access to the at least one system resource based on the validation result.

2. The method of claim 1, wherein the digital certificate includes verifiable credentials of the user that is requesting access to the at least one system resource.

3. The method of claim 2, wherein the verifiable credentials are issued by one or more service provider.

4. The method of claim 2, wherein the at least one verifiable credential of the user is sent from a verifier agent to a unified security bridge which sends the validation result to the authorization service.

5. The method of claim 4, wherein the unified security bridge is scalable to multiple authorization services and multiple service providers.

6. The method of claim 4, wherein the verifier agent verifies a wallet ID against the blockchain ledger network and sends the verification to the unified security bridge.

7. The method of claim 6, further comprising sending a user ID verify key to the blockchain ledger network and receiving a user ID verification response back to the verifier agent.

8. The method of claim 1, wherein the determining step comprises receiving the validation result from the blockchain ledger network and determining if verification is successful by determining a verifiable credential is valid and schema attributes satisfy a defined policy, and further comprising sending a decision back to an authentication module to permit access to the at least one system resource when the verifiable credential is valid and schema attributes satisfy the defined policy.

9. The method of claim 8, wherein the validation result is sent through a unified security bridge that supports a scalable verification model shared amongst multiple service providers each of which issue verifiable credentials to any number of users.

10. The method of claim 9, further comprising:
obtaining rules from the multiple service providers of credentials, and applying the rules to credentials associated with the verifiable credentials for each user; and
applying the rules by the unified security bridge to the verifiable credentials to determine whether the user is permitted access to the at least one system resource.

11. The method of claim 10, wherein the unified security bridge is scalable and communicates between the blockchain ledger network, multiple service providers and multiple authentication modules.

12. The method of claim 1, wherein the computing device includes software provided as a service in a cloud environment.

13. A computer program product comprising one or more computer readable storage media having program instructions collectively stored on the one or more computer readable storage media, the program instructions executable to:
obtain a user request to access at least one system resource;
obtain verifiable credentials of the user requesting access to the at least one system resource;
validate the verifiable credentials with a blockchain ledger network; and
permit the user access to the at least one system resource based on a successful validation result.

14. The computer program product of claim 13, further comprising authenticating users to login to endpoints and authorizing access to the at least one system resource using a decentralized and self-sovereign identity (SSI) security model.

15. The computer program product of claim 14, wherein the decentralized and self-sovereign identity (SSI) security model comprises a unified interface bridging between a blockchain-based platform and multiple pluggable authentication modules on endpoints to automate authentication and authorization workflow.

16. The computer program product of claim 13, further comprising providing verifiable credentials from multiple third-party issuers of digital certificates.

17. The computer program product of claim 13, wherein the validating of the verifiable credentials is through a unified security bridge that supports a scalable verification model shared amongst multiple service providers each of which provide the verifiable credentials to a digital wallet owned by a user.

18. A system comprising:
a processor, a computer readable memory, one or more computer readable storage media, and program instructions collectively stored on the one or more computer readable storage media, the program instructions executable to:
bridge communication between at least one authentication module and a blockchain ledger network, comprising:
obtaining verifiable credentials of multiple users from the at least one authentication module at the endpoints;
receiving verification from the block chain ledger network that the verifiable credentials are valid and access to a service provided by any one of the multiple service providers that issued the verifiable credentials is authorized; and
providing authorization to the at least one authentication module that a user requesting a service from any of the multiple service providers can access the service.

19. The system of claim 18, wherein the verification includes applying rules against the verifiable credentials.

20. The system of claim 18, wherein the verification is provided to a verifying agent from the blockchain ledger network, upon a request, and the bridging is provided by a unified security bridge that support a scalable verification model shared amongst multiple service providers each of which provide the verifiable credentials to a user within a digital wallet owned by the user.
